(19) United States
(12) Patent Application Publication
(10) Pub. No.: US 2004/0139243 A1
(43) Pub. Date: Jul. 15, 2004

(54) Identification information acquisition apparatus, identification information output apparatus, identification system, and identification information acquisition method and program

(75) Inventor: Atsuhiko Amagami, Tokyo-to (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/719,761

(22) Filed: Nov. 21, 2003

(30) Foreign Application Priority Data
Nov. 26, 2002 (JP) 2002-342969

(51) Int. Cl. G06F 3/00

(52) U.S. Cl. 710/16

(57) ABSTRACT

An identification information acquisition apparatus for acquiring identification information set in an external device includes a first acquisition portion for acquiring a first identification signal output from a first terminal of an external device, a second acquisition portion for acquiring a second identification signal output from the first terminal in a state where a first change signal that instructs to change a signal output from the first terminal has been output to a second terminal of the device, and an identification information determination portion for determining identification information on the basis of the first and second identification signals.

### FIELD AND BACKGROUND OF INVENTION

The present invention relates to an identification information acquisition apparatus, identification information output apparatus, identification system, and identification information acquisition method and program. In particular, the present invention relates to an identification information output apparatus that outputs preset identification information through a terminal and an identification information acquisition apparatus that acquires identification information preset in the identification information output apparatus, and a method and program for implementing these apparatuses.

Apparatus such as notebook personal computers including devices such as a liquid crystal panel and a keyboard acquire identification information identifying the type, functions, manufacturer, and revision of those devices through a connector in order to identify their type. An example of such technology can be found in Japanese Published Unexamined Patent Application No. 11-110332.

The number of pieces of identification information that can be represented by n bits, or n terminals of a connector is 2 raised to the nth power. As the number of device types to be identified increases, the number of terminals must be increased. Therefore, it is desirable to increase the number of pieces of identification information that can be represented by the same number of terminals.

One purpose of the present invention therefore is to provide an identification information acquisition apparatus, an identification information output apparatus, an identification system, an identification information acquisition method, and a program for the method.

### SUMMARY OF THE INVENTION

According to a first embodiment of the present invention, there are provided an identification system, an identification information acquisition apparatus, an identification information output apparatus, and an identification acquisition apparatus for the identification system, and a program used for the identification information identification apparatus; the identification system having an identification information output apparatus for outputting preset identification information and an identification information acquisition apparatus for acquiring the identification information, wherein the identification information output apparatus comprises: a first terminal for outputting a first identification signal forming a part of the identification information; a second terminal through which a first change signal for instructing to change a signal output from the first terminal is input; and an output setting circuit for causing a second identification signal forming a part of the identification information to be output from the first terminal in a state in which the first change signal has been input to the second terminal, and the identification information acquisition apparatus comprises: a first acquisition portion for acquiring the first identification signal output from the first terminal; a second acquisition portion for acquiring the second identification signal output from the first terminal in a state in which the first change signal has been output to the second terminal.

### BRIEF DESCRIPTION OF DRAWINGS

Some of the purposes of the invention having been stated, others will appear as the description proceeds, when taken in connection with the accompanying drawings, in which:

FIG. 1 shows a configuration of an identification system 10 according to an embodiment of the present invention;

FIG. 2 shows exemplary wiring-based configurations of an identification information setting portion 130 according to the embodiment of the present invention;

FIG. 2(a) shows a first exemplary wiring-based configuration of the identification information setting portion 130,

FIG. 2(b) shows a second exemplary wiring-based configuration of the identification information setting portion 130, and

FIG. 2(c) shows a third exemplary wiring-based configuration of the identification information setting portion 130;

FIG. 3 shows exemplary logic-element-based configurations of the identification information setting portion 130 according to the embodiment of the present invention;

FIG. 3(a) shows a first exemplary logic-element-based configuration of the identification information setting portion 130,

FIG. 3(b) shows a second exemplary logic-element-based configuration of the identification information setting portion 130, and

FIG. 3(c) shows a third exemplary logic-element-based configuration of the identification information setting portion 130;

FIG. 4 shows an exemplary configuration of the identification information setting portion 130 using a NOT logic element 410 according to the embodiment of the present invention;

FIG. 5 shows comparison between prior-art identification information and an example of identification information set by the identification system 10 according to the embodiment of the present invention; FIG. 5(a) shows the prior-art identification information and FIG. 5(b) shows the identification information set by the identification system 10 according to the embodiment of the present invention;

FIG. 6 shows a process for acquiring identification information performed by the identification system 10 according to the embodiment of the present invention; and

FIG. 7 shows an exemplary configuration of an information processing apparatus 20 having an identification information acquisition apparatus 110 according to the embodiment of the present invention.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

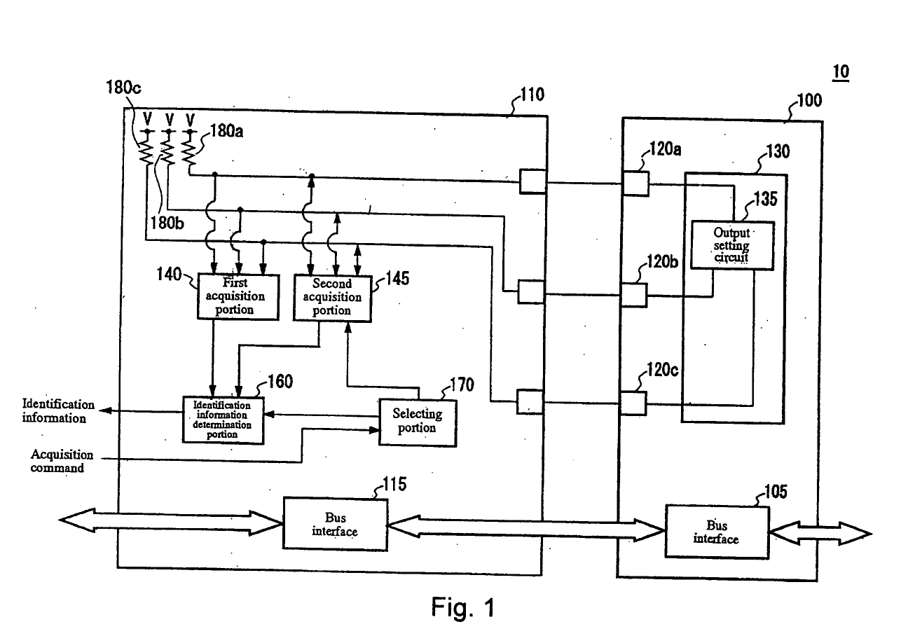

FIG. 1 shows a configuration of an identification system 10 according to an embodiment of the present invention. The identification system 10 comprises an identification information output apparatus 100 for outputting preset identification information for identifying information such as the type, functions, manufacturer, or revision of an apparatus and an identification information acquisition apparatus 110 for acquiring the identification information set in the identification information output apparatus 100. The identification information output apparatus 100 and the identification information acquisition apparatus 110 according to the present embodiment send and receive identification information through three terminals 120a to 120c. The identification system 10 according to the present embodiment uses the three terminals to send and receive eight (the third power of 2) or more pieces of identification information.

The identification information output apparatus 100 according to the present embodiment is provided in a peripheral device connected to an information processing apparatus through the identification information acquisition apparatus 110 and has a bus interface 105, terminals 120a to 120c, and identification information setting portion 130. The bus interface 105 transfers data between peripherals connected to the identification information output apparatus 100 and the information processing apparatus connected through the identification information acquisition apparatus 110 with the peripherals. Each of the terminals 120a to 120c is used as a first or second terminal. A terminal 120 used as the first terminal outputs a first identification signal that forms a part of identification information to the identification information acquisition apparatus 110. Into a terminal 120 used as the second terminal, a first change signal is input, which is output from the identification information acquisition apparatus 110 for providing an instruction to making a change to a signal output from the other terminal 120 used as the first terminal. The terminal 120 used as the second terminal may output a third identification signal that forms a part of identification information to the identification information acquisition apparatus 110.

The identification information setting portion 130 set identification information to be output by the identification information output apparatus 100 through the terminals 120a to 120c. The identification information output by the identification information output apparatus 100 is determined on the basis of an identification signal output from the terminals 120a to 120c when the identification information acquisition apparatus 110 does outputs no signal to any of the terminals 120a to 120c and an identification signal output from the terminals 120a to 120c when the identification information acquisition apparatus 110 outputs at least one of the terminals 120a to 120c. The latter identification signal is determined by the predefined relationship between a terminal to which a signal is input and a terminal that outputs a signal. The identification system 10 according to the present embodiment uses the value of identification signals output from the terminals 120a to 120c in a state where the identification information acquisition apparatus 110 outputs no signal to any of the terminals 120a to 120c, in combination with possible relationships between the terminals, thereby allowing a large number of pieces of identification information as compared with the case of using only the value of identification signals.

The identification information setting portion 130 includes an output setting circuit 135 for setting relationships between the terminals. The output setting circuit 135 causes the terminal 120 used as the second terminal to output the second identification signal forming a part of identification information when a first change signal is input to the terminal 120 used as the first terminal. In an arrangement in which the second terminal outputs a third identification signal to the identification information acquisition apparatus 110, the output setting circuit 135 outputs the second identification signal through the first terminal when the first change signal different form the third identification signal is input through the second terminal.

The identification information acquisition apparatus 110 has a bus interface 115, a first acquisition portion 140, a second acquisition portion 145, an identification information determination portion 160, a selecting portion 170, and a resistors 180a to 180c. The bus interface 115 transfers data between an information processing apparatus in which the identification acquisition apparatus 110 and peripherals connected to the identification information output apparatus 100. The first acquisition portion 140 acquires the first identification signal output from the first terminal of the identification information output apparatus 100, which is an external device, and the third identification signal output from the second terminal.

The second acquisition portion 145 outputs a first change signal indicating a change to a signal output from the first terminal to the second terminal and, in this state, acquires the second identification signal output from the first terminal. The second acquisition portion 145 outputs as the first change signal a signal which has a value different from that of the signal that is output from the second terminal when the terminal 120 used as the first terminal outputs the first identification signal. When the identification information acquisition apparatus 110 outputs no signal to any of the terminals 120a to 120c and the terminal 120 that is used as the first terminal outputs the third identification signal, the second acquisition portion 145 outputs as the first change signal a signal having a value different from that of the third identification signal.

The second acquisition portion 145 outputs to the first terminal a second change signal having a signal value different from that of the first identification signal output from the first terminal and, in this state, acquires a fourth identification signal output from the second terminal.

The identification determination portion 160 determines identification information set by the identification setting portion 130, on the basis of the first and third identification signal obtained by the first acquisition portion 140 and the second and fourth identification signal acquired by the second acquisition portion 145. The identification information determination portion 160 then outputs identification information in response to an instruction from the information processing apparatus in which the identification information acquisition apparatus 110 is provided.

The selecting portion 170 receives an instruction to acquiring identification information from the information processing apparatus in which identification information output apparatus 100 is provided, selects one of the terminals 120a to 120c of the identification information output apparatus 100 as the second terminal, and selection in the second acquisition portion 145. In response to this, the second acquisition portion 145 uses the terminal 120 selected as the second terminal and a terminal 120 that is different from the terminal selected as the second terminal and used as the first terminal to acquire the second identification signal and a fourth identification signal.

The resistors 180a to 180c pull up the terminal 120a to 120c to set the signal value of a terminal 120 for which the signal value is not set by the identification information setting portion 130 to the H level (logical 1). This allows the terminal 120a to 120c outputs an H-level signal unless the L level is set by the identification information setting portion 130. The resistors 180a to 180c may alternatively be provided in the identification information output apparatus 100 or may be provided on a line connecting the identification information output apparatus 100 with the identification information acquisition apparatus 110. Furthermore, the resistors 180a to 180c may pull down the terminals 120a to 120c to set the signal value of a terminal 120 for which the signal value is not set by the identification information setting module 130 to the L level (logical 0).

According to the identification system 10 described above, identification information can be determined on the basis of the first and third identification signal that are output from the terminals 120a to 120c when no signals are output to the terminal 120a to 120c, the second identification signal output from the terminal 120 that is used as the first terminal when the fist change signal is output to the terminal 120 used as the second terminal, and the fourth identification signal output from the terminal 120 used as the second terminal when the second change signal is output to the terminal 120 used as the first terminal. Different values can be set for the second and fourth identification signals according to the relationship between the first and second terminals that is set by the output setting circuit 135. Consequently, the identification system 10 allows a large number of pieces of identification information as compared with the case of using only the first and third identification signals.

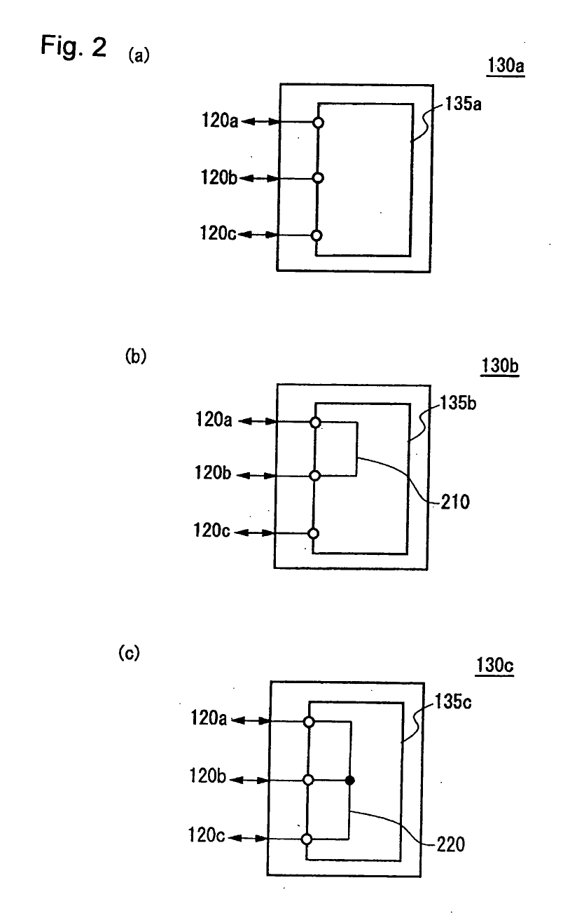

FIG. 2 shows an exemplary wiring-based configuration of the identification information setting portion 130 according to an embodiment of the present invention.

FIG. 2(a) shows an identification information setting portion 130a, which represents a first exemplary wiring-based configuration of the identification information setting portion 130. The identification information setting portion 130a has an output setting circuit 135a that has a configuration in which terminals 120a to 120c are not interconnected. Given that the terminal 120a is the second terminal and the terminals 120b and 120c are the first terminal, the output setting circuit 135a outputs a first identification signal “11” and a third identification signal “1”. When the second acquisition portion 145 outputs a first change signal “0”, which differs from the value of the third identification signal, to the terminal 120a, the signal values of the terminals 120b and 120c do not change and the second identification signal becomes “1”. Likewise, when the second acquisition portion 145 outputs the second change signal “0”, which differs from the value of the first identification signal, to at least one of the terminals 120b and 120c, the signal value of the terminal 120a does not change and the fourth identification signal becomes FIG. 2(b) shows an identification information setting portion 130b, which represents a second exemplary wiring-based configuration of the identification information setting portion 130. An output setting circuit 135b in the identification information setting portion 130b has a line 210 that provides electrical connection between a terminal 120a used as the first terminal and terminals 120b used as the second terminal. Like the one shown in FIG. 2(a), the output setting circuit 135b in this exemplary configuration outputs a first identification signal “11” and a third identification signal “1”. When a first change signal “0” is input to the terminal 120a, the output setting circuit 135b outputs a second identification signal “01,” from the terminals 120b and 120c. When a second change signal “0” is input to the terminal 120b, the output setting circuit 135b outputs a fourth identification signal “0” from the terminal 120a. When the second change signal “0” is input to the terminal 120c, the output setting circuit 135c outputs a fourth identification signal “1” from the terminal 120a.

FIG. 2(c) shows an identification information setting portion 130c, which represents a third exemplary wiring-based configuration of the identification information setting portion 130. An output setting circuit 135c in the identification information setting portion 130c has a line 220 that provides electrical connection between a terminal 120a used as the first terminal and terminals 120b and 120c used as the second terminal. Like the one shown in FIG. 2(a), the output setting circuit 135c in this exemplary configuration outputs a first identification signal “11” and a third identification signal “1”. When a first change signal “0” is input to the terminal 120a, the output setting circuit 135c outputs a second identification signal “00” from the terminals 120b and 120c. When a second change signal “0” is input to the terminal 120b, the output setting circuit 135c outputs a fourth identification signal “0” from the terminal 120a. When the second change signal “0” is input to the terminal 120c, the output setting circuit 135c outputs a fourth identification signal “0” from the terminal 120a.

As described above, whereas the identification information setting portions 130a to 130c outputs the same first and third identification signals, it outputs different second and fourth identification signals because different relationships between the terminals 120a to 120c are provided. Thus, the identification information determination portion 160 can determine identification information on the basis of the first, second, third, and fourth identification signals to identify the different identification information setting portions 130a to 130c.

The second acquisition portion 145 in the wiring-based configuration described above may output the first change signal to the second terminal and acquire the second identification signal when the first and third identification signals have the same signal value. In that case, the second acquisition portion 145 performs the operation to acquire the second signal only when the first and second terminals are likely to be electrically continuous with each other. Accordingly, the time required for acquiring the identification information can be reduced. Likewise, the second acquisition portion 145 may acquired the fourth identification signal when the first and third identification signals have the same signal value.

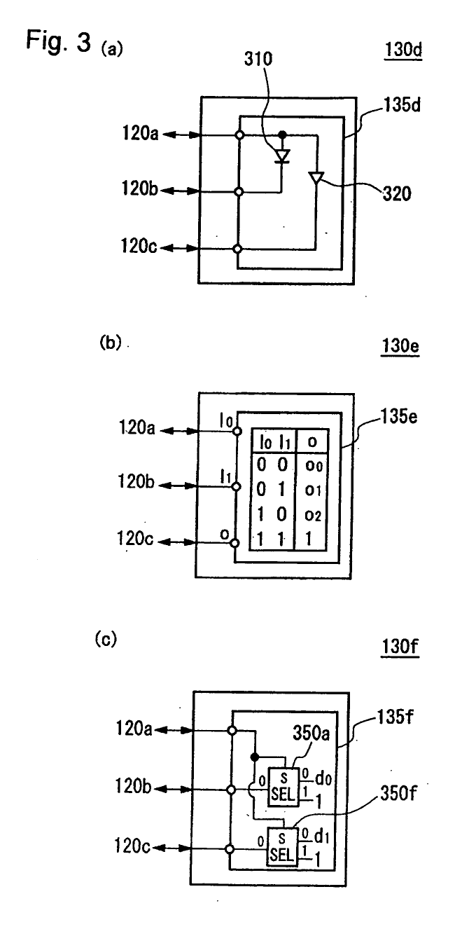

FIG. 3 shows an exemplary logic-element-based configuration of the identification information setting portion 130 according to an embodiment of the present invention.

FIG. 3(a) shows an identification information setting portion 130d which represents a first example of logic-element-based configuration of the identification information setting portion 130. An output setting circuit 135d in the identification information setting portion 130d has a rectifier 310 for preventing backflow of current from a terminal 120b used as the first terminal to a terminal 120a used as the second terminal and a driving element 320, which is a open-collector or open-drain logic element that outputs a first or second identification signal. Given that the terminals 120b and 120c are the first terminal and the terminal 120a is the second terminal, the output setting terminal 135d outputs a first identification signal “11” and a third identification signal “1”. When the second acquisition portion 145 outputs a first change signal “0” to the terminal 120a, a second identification signal “10” is output from the terminals 120b and 120c. On the other hand, when the second acquisition portion 145 outputs a second change signal “0” to the terminal 120b, the fourth identification signal, which is the signal value of the terminal 120a becomes “0”. When the second acquisition portion 145 outputs the second change signal “0” to the terminal 120c, the fourth identification signal, which is the signal value of the terminal 120a, becomes “1”.

In this way, the rectifier 310 or the driving element 320 can be used to pass current from the terminal 120a to only the terminal 120b or the 120c. Consequently, an increased number of combinations of relationships between the two terminals can be set. Furthermore, because the driving element 320 is an open-collector or open-drain logic element, the driving element 320 can be protected from damage, which would otherwise be caused by the output of the first change signal from the second acquisition portion 145 to the terminal 120c.

FIG. 3(b) shows an identification information setting portion 130e which represents a second exemplary logic-element-based configuration of the identification information setting portion 130. An output setting circuit 135 in the identification information setting portion 130e generates O, which is the result of a logic operation of the signal values I0 and I1, which are input from terminals 120a and 120b used as the second terminal, according to a truth table. The output setting circuit 135e has a combinational logic circuit that provides sets of inputs and outputs according the truth table. In this example, the output setting circuit 135e outputs a first identification signal “1” and the third identification signal “11”. Furthermore, the output setting circuit 135e outputs a second identification signal O0 in response to a first change signal “00” for the inputs I0 and I1, and outputs a second identification signal O1 in response to a first change signal “01”, and outputs a second identification signal O2 in response to a first change signal “10”. The output setting circuit 135e can set different pieces of identification information by setting the signals O0 to O2 to different values.

FIG. 3(c) shows an identification information setting portion 130f, which represents a third exemplary logic-element-based configuration of the identification information setting portion 130. An output setting circuit 135f in the identification information setting portion 130f has selectors 350a to 350b that output an identification signal corresponding to the signal value of the terminal 120a. The selectors 350a to 350b according to the present embodiment outputs “11” from the terminals 120b and 120c when the signal value of the terminal 120a is “1” and outputs “d0d1” from the terminals 120b and 120c when the signal value of the terminal 120a is “0”.

In this example, the output setting circuit 135f receives the signal value of the terminal 120a. When the signal value of the terminal 120a is “1”, which is a third identification signal, the output setting circuit outputs a first identification signal “11” to the terminals 120b and 120c. On the other hand, when the signal of the terminal 120a is “0”, which is a first change signal, the output setting circuit 135f outputs a second identification signal “d0d1” to the terminals 120b and 120c. The output setting circuit 135f can have different pieces of identification information by setting the signals d0 and d1 to different values.

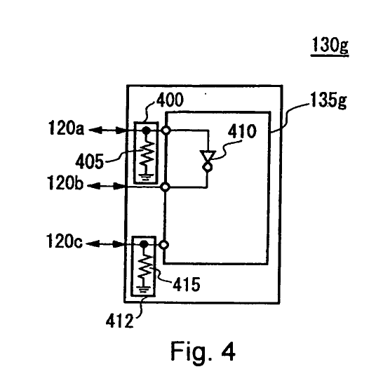

FIG. 4 shows an identification information setting portion 130g, which represents an exemplary configuration of the identification information setting portion 130 that uses a NOT element 410 according to an embodiment of the present invention. The identification information setting portion 130g has an output setting circuit 135g and pull-down components 400 and 412. The output setting circuit 135g has a NOT element 410 that outputs the logical negation of the signal value of a terminal 120a used as the second terminal to a terminal 120b used as the first terminal. The pull-down component 400 pulls down the terminal 120a through its pull-down resistor 405 having a resistance lower than the resistor 180a in the identification information acquisition apparatus 110 that pulls up the terminal 120a. The pull-down component 412 has a pull-down resistor 415 that outputs as at least a part of a first identification signal the signal value 0 based on a predetermined potential to a terminal 120c.

When the identification information acquisition apparatus 110 outputs no signal to the terminals 120a to 120c, the signal value of the terminal 120a is set to “0” by the pull-down resistor 405. As a result, the signal value of the terminal 120b becomes “1” due to the NOT element 410. Accordingly, the identification information setting portion 130g outputs the first identification signal “10” and a third identification signal “0”. When the second acquisition portion 145 outputs a first change signal “1” to the terminal 120a, the terminal 120b outputs a second identification signal “0”.

As can be seen from the foregoing description, the identification information setting portion 130g can invert the third identification signal because the pull-down component 400 is connected to the terminal 120a. Furthermore, a relationship can be provided between the first and second terminals while causing the first identification signal output from the first terminal to be the logical negation of the third identification signal output from the second terminal by using the NOT element 410. Moreover, the pull-down resistor 415 connected to the terminal 120c can set the first identification signal to “0” and set as the first identification signal a signal value different from the signal pulled up by the resistors 180a to 180c.

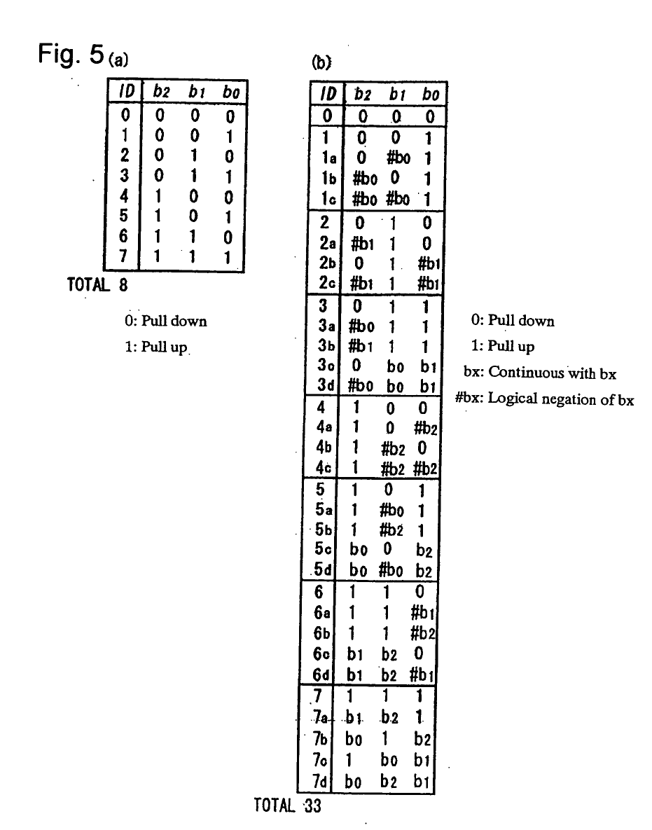

FIG. 5 shows comparison between prior-art identification information and an example of identification generated by the identification system 10 according to an embodiment of the present invention.

FIG. 5(a) shows identification information according to the prior art. Symbols b2 to b0 in the figure indicate signal values output from terminals 120a to 120c. Symbol “ID” indicates identification information determined by corresponding b2 to b0. According to the prior art, eight (the third power of 2) pieces of identification information can be set by using the three terminals 120a to 120c.

FIG. 5(b) shows an example of identification information set by the identification system 10 according to the present embodiment of the invention. In FIG. 5(b), the relationship between the terminals is set based on whether or not electrical connection is provided between the first and second terminals, or on whether or not the logical negation value of the signal value of the second terminal is regarded as the signal value of the first terminal. Here, with respect to the signal values of b2-b0 in FIG. 5(b), “0” is for pull down, “1” for pull up, “bx” for continuous with bx, and “#bx” for logical negation value of bx.

For example, if a first and third identification signals output from the terminals 120a to 120c is “011”, a second and fourth signals are used to provided identifications as illustrated by “3”, “3a”, “3b”, “3c”, and “3d”.

The identification “3” indicates the case in which the terminals 120a to 120c are insulated from each other and therefore no relationship is provided between them. The ID “3a” indicates the case where the signal value of the first terminal is the logical negation of the second terminal when the first terminal is the terminal 120a and the second terminal is 120c. The ID “3b” indicates the case where the signal value of the first terminal is the logical negation of that of the second terminal when the first terminal is 120a and the second terminal is 120b. The ID “3c” indicates the case where there is electrical connection between the terminal 120b and 120c. The ID “3d” indicate the case where electrical connection between the terminal 120b and the terminal 120c is provided and the signal value of the terminal 120a is the logical negation of that of the terminal 120c.

As can be seen from FIG. 5(b), five piece of identification information in which the first and third identification signals output from the terminals 120a to 120c are “011” can be set by using relationships between the terminals. Likewise, a plurality of pieces of identification information can be set for cases in which the values of the first and third identification signals are not “011”. This allows many pieces of identification information compared with the prior art. While only electrical connection and logical negation are used for relationships between the terminals in FIG. 5(b), a rectifier 310, driving element 320, a combinational logic circuit, a selector 350, or other elements may be used to set more pieces of identification information.

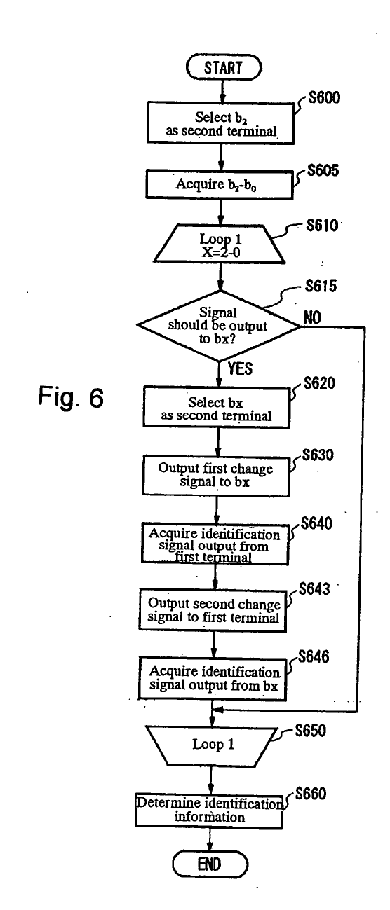

FIG. 6 shows a process for acquiring identification information performed by the identification system 10 according to an embodiment of the present invention.

First, the selecting portion 170 selects a terminal 120a (b2) as the second terminal (S600). Then the first acquisition portion 140 acquires a third identification signal output from the terminal 120a and a first identification signal output from a terminal 120b-120c when the identification information acquisition apparatus 110 outputs no signal to any of the terminals 120a to 120c (S605).

The selecting portion then determines whether or not a signal should be output to the terminals 120a to 120c (S610 and S615). For example, the selecting portion 170 makes the determination on the basis of the following criteria:

(1) Only the terminal predetermined in the identification system 10 is used as the second terminal. This can prevent a signal from the identification information acquisition apparatus 110 from being input into that predetermined terminal. Thus, damage to the logic elements in the output setting circuit 135 can be prevented when the identification information acquisition apparatus 110 output to the terminal 120.

(2) Among the plurality of terminals 120a to 120c that output identification signals, including first and third identification signals, only the terminal that outputs an identification signal that value of which is equal to a preset value is selected as the second terminal. Thus, only the terminal that is likely to have electrical connection can be selected in a case where relationship between terminals are established on the basis of whether or not electrical connection should be provided between them.

(3) Among the signal values of a plurality of identification signals, including first and third signals, output from the terminals 120a to 120c, the most frequently appearing signal value, which is output from the largest number of terminals, is selected. Then, every one of the terminals 120a to 120c that outputs the most frequently appearing signal is selected in turn as the second terminal. For example, if the terminals 120a to 120c output the identification signal “110” as the first or third identification signal, the selecting portion 170 selects the signal value “1” output from the two terminals as the most frequently appearing signal value. Then it selects as the second terminal the terminals 120a and 120b in turn that output the most frequently appearing signal as an identification signal. The selecting portion 170 then causes the second acquisition portion to acquire the second identification signal for each of the selected second terminals. Thus, electric connection, the rectifier 310 and/or driving element 320 can be used to select and use as the second terminal the terminals outputting the most frequently appearing signal value, which allow a larger number of combinations of second identification signals, from between the plurality of terminals outputting the identification signal “0” and the plurality of terminals outputting the identification signal “1”.

The selecting portion 170 selects (S620) as the second terminal a terminal in turn from among the terminals 120a to 120c that has been found to output a signal at step S615.

Then, the second acquisition portion 145 outputs to each of the second terminal 120 (bx) selected by the selecting portion 170 a first change signal associated with the selected second terminal to the selected second terminal (S630) and acquires a second identification signal output from a first terminal different from the second terminal among the terminals 120a to 120c (S640). The first change signal output from the second acquisition portion 145 is a signal having a value different from that of a third identification signal output from the second terminal.

The second acquisition portion 145 outputs a second change signal to the first terminal (S643) and acquires a fourth identification signal output from the second terminal (S646). Here, the second change signal output by the second acquisition portion 145 is a signal having a value different from that of the first identification signal output from the first terminal.

In alternative example, the second acquisition portion 145 performs steps S630 and S640 and/or S643 and S646 if the first identification signal and the third identification signal has the same value or if the value of the first identification signal is the logical negation of the value of the third identification signal.

The identification information acquisition apparatus 110 selects terminals in turn as the second terminal and repeats the process from step S620 to S646 (S650). At step S605, the identification information determination portion 160 determines identification information on the basis of the first and third identification signals obtained by the first acquisition portion 140, and the second and fourth identification signals selected by the second acquisition portion 145 at steps S640 and S646 corresponding each of the second terminals sequentially selected by the selecting portion 170 (S660).

In this way, the foregoing description, the identification information acquisition apparatus 110 can select the terminals 120a to 120c in turn as the second terminal and output the first change signal to the selected terminal to examine the relationship established between the terminals 120a to 120c. This allows identification information to be obtained even if no setting indicating which of the terminals 120a to 120c is the second terminal is made in the identification information acquisition apparatus 110.

The method described above can be modified as described below to examine the relationship between the terminals in a case where there are a plurality of second terminals.

At steps 610 and S620, the selecting portion 170 selects a plurality of second terminals. Then, at steps 630 and S640, the second acquisition portion 145 outputs to at least some of the plurality of second terminals a first change signal having a value different from that of a third identification signal output from those second terminals and acquires a second identification signal that is output to the first terminal by the identification information setting portion 130 performing logical operations on the plurality of the signal values. The second acquisition portion 145 may acquire a second identification signal for all possible combinations of signal values of the plurality of second signal. At step S660, the identification information determination portion 160 identifies the type of the logical operation on the basis of the signal values output from the second terminals at step S630 and the second identification signal acquired at step S640. The identification information determination portion 160 then determines identification information on the basis of the first identification signal, a plurality of third identification signals output from the plurality of second terminals, and the type of the logic operation identified.

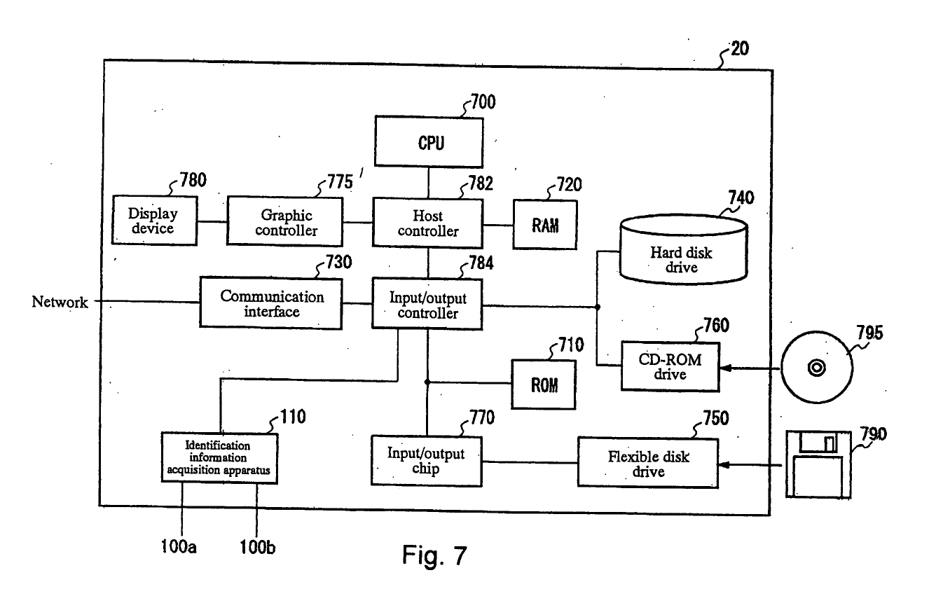

FIG. 7 shows an exemplary hardware configuration of an information processing apparatus 20 according to an embodiment of the present invention. The information processing apparatus 20 according to the present embodiment comprises a CPU section including a CPU 700, a RAM 720, a graphic controller 775, and a display device 780, which are interconnected by a host controller 782, an input/output section including a communication interface 730, a hard disk drive 740, a CD-ROM drive 760, and an identification information acquisition apparatus 110, which are connected to the host controller 782 through an input/output controller 784, and a legacy input/output section including a ROM 710, a flexible disk drive 750, and an input/output chip 770, which are connected to the input/output controller 784.

The host controller 782 connects the RAM 720 to the CPU 700 and the graphic controller 775, which access the RAM 720 at a high transfer rate. The CPU 700 operates according to programs stored in the ROM 710 and the RAM 720 to control each component. The graphic controller 775 acquires image data generated on a frame buffer provided in the RAM 720 by the CPU 700 and displays it on the display apparatus 780. Alternatively, the graphic controller may have a frame buffer for storing image data generated by the CPU 700 within it.

The input/output controller 784 connects the host controller 782 with the communication interface 730, the hard disk drive 740, the CD-ROM drive 760, and identification information acquisition apparatus 110, which are relatively fast input/output devices. The communication interface 730 communicates with other apparatuses over a network. The hard disk drive 740 stores programs and data used by an identification information output apparatus 100. The CD-ROM drive 760 reads a program or data from a CD-ROM 795 and provides it to the identification information acquisition apparatus 110. The identification information acquisition apparatus 110 obtains identification information from identification information output apparatuses 100a and 100b and provides it to the CPU 700.

Connected to the input/output controller 784 are relatively slow input/output devices such as the ROM 710, the flexible disk drive 750, and the input/output chip 770. The ROM 710 stores a boot program executed by the CPU 700 on activation of the information processing apparatus 20 and programs dependent on the hardware of the information processing apparatus 20. The flexible disk drive 750 reads a program or data from a flexible disk 790 and provides it to the identification information acquisition apparatus 110 through the RAM 720 and the input/output controller. Connected to the input/output chip is a flexible disk 790 as well as input/output devices through a parallel port, serial port, keyboard port, and mouse port.

The program to be provided to the identification information acquisition apparatus 110 through the RAM 720 is stored in a recording medium such as flexible disk 790, CD-ROM 795, or IC card and provided by a user. The program is reads from the recording medium, installed in the identification information acquisition apparatus 110 through the input/output controller 784 and the RAM 720, and executed in the identification information acquisition apparatus.

The program installed and executed in the identification information acquisition apparatus 110 comprises a first acquisition module, a second acquisition module, an identification information determination module, and selecting module. The program or modules causes the identification information acquisition apparatus to operate as the first acquisition portion 140, second acquisition portion 145, identification information determination portion 160, and selecting portion 170.

The program or modules mentioned above may be stored in an external storage medium. The storage medium may be an optical recording medium such as a DVD and PD, a magneto-optical disk such as an MD, a tape medium, or semiconductor memory such as an IC card as well as a flexible disk 790 and CD-ROM 795. Alternatively, a storage device such as a hard disk or RAM provided in a server system connected onto a private communication network or the Internet may be used as a recording medium for the program and the program may be provided to the identification information acquisition apparatus 110 over the network.

The identification information acquisition apparatus 110 may be contained in the input/output controller 784 or the input/output chip 770.

Furthermore, the identification information acquisition apparatus 110 may be an information processing apparatus comprising at least some of the CPU 700, ROM 710, RAM 720, communication interface 730, hard disk drive 740, flexible disk drive 750, CD-ROM drive 760, input/output chip 770, Graphic controller 775, display apparatus 780, host controller 782, and input/output controller 784 of the information processing apparatus 20. In that case, the first acquisition portion 140 and the second acquisition portion 145 may acquire identification information through a General Purpose I/O (GPIO) interface provided in the input/output controller 784 or the input/output chip 770 according to a program installed in the hard disk drive 740, read into the RAM 720, and executed by the CPU 700. Moreover, the identification information determination portion 160 and the selecting portion 170 may be implemented by a program installed in the hard disk drive 740, read into the RAM 720, and executed by the CPU 700.

While the present invention has been described with respect to the embodiments, the technical scope of the present invention is not limited to the embodiments described herein. Various modification or improvements may be made to the embodiments. It will be appreciated that embodiments to which such modification or improvements are also fall into the technical scope of the present invention.

For example, the identification system 10 of the present embodiment may be used on production lines or in delivery system in addition to applications in which peripheral devices connected to an apparatus such as an information processing apparatus are identified.

On a production line, for example, an identification information output apparatus 100 is installed in each products being manufactured. Identification information set in each product by an identification information acquisition apparatus 110 provided in a predetermined production stage and a process associated with the identification information is performed. Thus, different manufacturing processes can be applied to different products.

In a delivery system, an identification information output apparatus 100 is included in each package. An identification information acquisition apparatus 110 provided in each distribution center acquires identification information set for each package. Thus, each package can be delivered to destination determined on the basis of the identification information and each package can be tracked.

The identification system 10 according to the present embodiment uses a relatively simple circuit, such as a wiring circuit, a rectifier, or a combinational logic circuit to set relationships between terminals. Thus, many pieces of identification information can be set with a small number of terminals. Accordingly, the identification information output apparatus 100 can be implemented at low costs and therefore suitable for the applications mentioned above.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a first acquisition element which acquires from another device a first identification signal output at a first terminal of the other device;
a second acquisition element which acquires from the other device a second identification signal output at said first terminal in a state in which a first modification signal directing change to the signal output at said first terminal is output to a second terminal of the other device; and
an identification information determining element which determines information identifying the other device based on the acquired first and second identification signals.

2. Apparatus according to claim 1 wherein said first acquisition element further acquires a third identification signal output at said second terminal; said second acquisition element acquires said second identification signal output from said first terminal in a state in which said second acquisition portion has output said first modification signal to have a value different from the value of said third identification signal; and said identification information determining element determines said identification information on the basis of the acquired first, second and third identification signals.

3. Apparatus according to claim 2 wherein said second acquisition element outputs said first modification signal to said second terminal to acquire said second identification signal in a state in which said first identification signal and the third identification signal have the same value.

4. Apparatus according to claim 2, wherein said second acquisition element outputs said first modification signal to said second terminal to acquire said second identification signal in a state in which the value of said first identification signal is the logical negation of the value of said third identification signal.

5. Apparatus according to claim 2, wherein: said first acquisition element acquires said first signal output from said first terminal and a plurality of said third identification signals output from a plurality of said second terminals; said second acquisition element performs a logical operation on the signal values of said plurality of second terminals to acquire said second identification signal output at said first terminal in a state in which said second acquisition element has output said first modification signal having a value different from the value of said third identification signal output from at least one or some of said second terminals to said at least one or some of plurality of second terminals; and said identification information determination element identifies the type of said logic operation on the basis of correspondences between the signal values of said plurality of second terminals and said second identification signal and determines said identification information on the basis of said first identification signal, said plurality of third signal, and the type of said logical operation.

6. Apparatus according to claim 2, wherein said second acquisition element further acquires a fourth identification signal output from said second terminal in a state where a second modification signal having a value different from the value of said first identification signal is output at said first terminal; and said identification information determination element determines said first, second, third, and fourth identification signals.

7. Apparatus according to claim 2, further comprising a selecting element for selecting a plurality of terminals of said external device one by one as said second terminal, and further wherein: said second acquisition element acquires said second identification signal output from said first terminal different from one of said second terminals selected by said selecting element in a state in which said second acquisition element has output said first modification signal associated with said selected second terminal to said selected second terminal; and said identification information determination element determines said identification information on the basis of said first identification signal, a plurality of said second identification signals input by said second acquisition correspondingly to said second terminals selected by said selecting element, and said third identification signal.

8. Apparatus according to claim 7, wherein said selecting element
selects the frequently appearing signal value that is output from the largest number of terminals among the signal values of a plurality of identification signals including said first identification signal or said third identification signal output from said plurality of terminals,
selects as the second terminal from among said plurality of terminals the terminals one by one that output said frequently appearing signal value of an identification signal, and
causes said second acquisition element to acquire said second identification signal against each of said selected second terminals.

9. Apparatus comprising:
a first terminal at which a first identification signal which forms a part of device identification information is output;
a second terminal at which a first change signal is received which directs a change in the output from said first terminal; and
an output setting circuit operatively connected with said first and second terminals and directing that a second identification signal which forms a part of the device identification information be output from said first terminal in a state in which said first change signal has been input to said second terminal.

10. Apparatus according to claim 9, wherein: said second terminal outputs a third identification signal forming a part of the device identification information; and
said output setting circuit causes said second identification signal to be output from said first terminal in a state in which said first change signal having a value different from the signal value of said third identification signal has been input through said second terminal.

11. Apparatus according to claim 10, wherein: said output setting circuit inputs the signal value of said second terminal, and, in a state in which said second terminal has the signal value of said third identification signal, outputs said first identification signal to said first terminal, and, in a state in which said second terminal has the signal value of said first change signal, outputs said second identification signal to said first terminal.

12. Apparatus according to claim 10, wherein said output setting circuit has wiring for providing electrical connection between said first and second terminals.

13. Apparatus according to claim 12, further comprising a pull-down portion for said second terminal pulled up by a first resistor, and pulling down said second terminal by a second resistor having a value lower than that of said first resistor.

14. Apparatus according to claim 10, wherein said output setting circuit outputs the logical negation value of the signal value of said second terminal to said first terminal.

15. Apparatus according to claim 10, wherein said output setting circuit has a combinational logic circuit for outputting the result of a logical operation on the signal values of plurality of said second terminals to said first terminal.

16. Apparatus according to claim 10, wherein said output setting circuit has an open-collector logic output or open-drain logic output for outputting said first or second identification signal to said first terminal.

17. Apparatus according to claim 10, wherein said output setting circuit has a rectifier for preventing backflow of a current from said first terminal to said second terminal.

18. Apparatus according to claim 9, further comprising a third terminal connected to a predetermined potential for outputting said predetermined potential as at least part of said first identification signal forming a part of said identification information.

19. An identification system having an identification information output apparatus for outputting preset identification information and an identification information acquisition apparatus for acquiring said identification information, wherein,
said identification information output apparatus comprises:
a first terminal for outputting a first identification signal forming a part of said identification information;
a second terminal through which a first change signal for instructing to change a signal output from said first terminal is input; and
an output setting circuit for causing a second identification signal forming a part of said identification information to be output from said first terminal in a state in which said first change signal has been input to said second terminal, and
said identification information acquisition apparatus comprises:
a first acquisition portion for acquiring said first identification signal output from said first terminal;
a second acquisition portion for acquiring said second identification signal output from said first terminal in a state in which said first change signal has been output to said second terminal; and
an identification information determination portion for determining said identification information on the basis of said first and second identification signal.

20. An method for acquiring identification information configured for an external device, comprising:
acquiring a first identification signal output by a first terminal of said external device;
acquiring a second identification signal output by said first terminal in a state in which a first modification signal directing change to the signal output by said first terminal is output to a second terminal of said external device; and
determining said identification information based on said first identification signal and said second identification signal.

21. A recording medium on which a program used for an identification information acquisition apparatus for acquiring identification information set in an external device, said program causing said identification information acquisition apparatus to function as:
a first acquisition portion for acquiring a first identification signal output from a first terminal of said external device;
a second acquisition portion for acquiring a second identification signal output from said first terminal in a state in which a first change signal for instructing to change a signal output from said first terminal has been output to a second terminal of said external device; and
an identification information determination portion for determining said identification information on the basis of said first and second identification signal.

22. A program for an identification information acquisition apparatus for acquiring identification information set in an external device, said program causing said identification information acquisition apparatus to function as:
a first acquisition portion for acquiring a first identification signal output from a first terminal of said external device;
a second acquisition portion for acquiring a second identification signal output from said first terminal in a state in which a first change signal for instructing to change a signal output from said first terminal has been output to a second terminal of said external device; and
an identification information determination portion for determining said identification information on the basis of said first and second identification signals.
